(19) United States
(12) Patent Application Publication
(10) Pub. No.: US 2026/0307795 A1
(43) Pub. Date: Oct. 8, 2026

(54) MONUMENT DEPLOYABLE WORK SURFACE

(71) Applicant: B/E Aerospace, Inc., Winston Salem, NC (US)

(72) Inventors: Kyle Nathen Swen, Crystal Lake, IL (US); Travis John Vaninetti, Bothell, WA (US); Michael Boyd, Walkertown, NC (US); Jefferey M. McKee, Duvall, WA (US); Travis K. Finlay, Durham, NC (US)

(73) Assignee: B/E Aerospace, Inc., Winston Salem, NC (US)

(21) Appl. No.: 19/637,523

(22) Filed: Apr. 2, 2026

Related U.S. Application Data
(60) Provisional application No. 63/783,796, filed on Apr. 4, 2025.

(51) Int. Cl. B64D 11/00

(52) U.S. Cl. CPC B64D 11/0023

(57) ABSTRACT

An aircraft monument may have a deployable workstation. The workstation may be deployable from a storage space between the first and second sidewalls of the monument. The workstation may be deployable in response to longitudinal translation of a front wall of the monument. The workstation may be coupled to the first and second sidewalls of the monument at a first hinge, about which the workstation may rotate from a vertical, stowed position to a horizontal, extended position. The workstation may comprise a plurality of panels. The panels may be foldable such that the workstation has a greater length in the horizontal, extended position than in the vertical, stowed position.

### CROSS REFERENCE TO RELATED APPLICATIONS

This application claims the benefit of and priority to U.S. Provisional Application No. 63/783,796, entitled “MONUMENT DEPLOYABLE WORK SURFACE,” filed on Apr. 4, 2025, which is hereby incorporated by reference in its entirety for all purposes.

### TECHNICAL FIELD

The present disclosure relates generally to an aircraft monument and, more particularly, to an aircraft monument with a deployable workstation.

### BACKGROUND

Aircraft cabins contain limited counterspace for cabin crew members. While some galleys may provide folding shelves or pull-out trays, these conventional solutions present several drawbacks. First, conventional work surfaces often extend into galley spaces or aisles, thereby impeding movement and operations of other crew members and interfering with concurrent galley services. Second, conventional solutions may convert or occupy surfaces needed by other crewmembers for concurrent operations, reducing overall galley efficiency. Third, conventional storage mechanisms for stowable work surfaces typically consume valuable storage space that would otherwise be available for galley supplies, equipment, or service carts.

### SUMMARY

In one aspect, a monument is disclosed. The monument may comprise a first sidewall extending between a ceiling and a floor, a second sidewall extending between the ceiling and the floor, a storage space disposed between the first sidewall and the second sidewall, a front wall translatable from the first sidewall and the second sidewall, and a workstation deployable from the storage space.

In various embodiments, in response to the front wall being translated in a first direction, the workstation may be free to deploy from a vertical position within the storage space to an extended position perpendicular to the front wall.

In various embodiments, the workstation may be rotatably coupled to the first sidewall and the second sidewall at a rear edge of the workstation via a first hinge.

In various embodiments, the workstation may be rotatably coupled to the front wall at a front edge of the workstation via a second hinge.

In various embodiments, translation of the front wall in the first direction may cause the workstation to deploy from the vertical position to the extended position.

In various embodiments, the workstation may comprise a first panel and a second panel coupled at a center hinge. In various embodiments, the workstation may have a total length in the extended position and a folded length in the vertical position. In various embodiments, the total length may be greater than the folded length.

In various embodiments, the workstation may further comprise a third panel and a fourth panel coupled to the first panel and the second panel at a center lateral hinge.

In various embodiments, the monument may further comprise a ledge disposed on the front wall. In various embodiments, the first panel may be a slab panel. In various embodiments, the second panel may be an approach panel configured to be supported by the ledge when in the extended position.

In various embodiments, the monument may further comprise a panel wall configured to extend from the storage space to form a privacy barrier.

In various embodiments, the monument may further comprise a handle disposed on the front wall for controlling a position of the front wall.

In another aspect, a monument is disclosed. The monument may comprise a storage space disposed between a first sidewall and a second sidewall, and a workstation deployable from the storage space to an extended position.

In various embodiments, the workstation may comprise a first panel coupled to the first sidewall and the second sidewall, and a second panel rotatably coupled to the first panel.

In various embodiments, the second panel may be configured to unfold longitudinally from the first panel to form a continuous worksurface.

In various embodiments, the workstation may further comprise a third panel and a fourth panel. In various embodiments, the third panel may be configured to unfold laterally from the first panel and the fourth panel may be configured to unfold laterally from the second panel to form an extended worksurface.

In another aspect, a monument system is disclosed. The monument system may comprise a monument having a first sidewall, a second sidewall, a front wall configured to be disposed between the first sidewall and the second sidewall in a first longitudinal position and translatable from the first sidewall and the second sidewall to a second longitudinal position, and a storage space formed between the first sidewall and the second sidewall; and a workstation configured to stow within the storage space in a vertical position and configured to deploy to an extended position in response to the front wall being translated to the second longitudinal position.

In various embodiments, the front wall may comprise a ledge for receiving the workstation.

In various embodiments, the workstation may be disposed at a height of between 32 inches and 60 inches when in the extended position.

In various embodiments, the workstation may be coupled to the first sidewall and the second sidewall via a first hinge.

In various embodiments, the workstation may be coupled to the front wall via a second hinge.

In various embodiments, the monument system may further comprise a rail system for controlling a position of the front wall.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 illustrates an aircraft, in accordance with various embodiments;

FIG. 2 illustrates an aircraft floorplan, in accordance with various embodiments;

FIG. 3 illustrates an aircraft monument in a stowed position, in accordance with various embodiments;

FIG. 4 illustrates an aircraft monument, in accordance with various embodiments;

FIG. 5 illustrates an aircraft monument in a deployed position, in accordance with various embodiments;

FIG. 6 illustrates an aircraft monument in a deployed position, in accordance with various embodiments;

FIG. 7 illustrates a monument workstation, in accordance with various embodiments;

FIG. 8 illustrates a monument workstation, in accordance with various embodiments;

FIG. 9 illustrates a monument workstation, in accordance with various embodiments;

FIG. 10 illustrates a monument workstation, in accordance with various embodiments;

FIG. 11 illustrates a monument workstation, in accordance with various embodiments;

FIG. 12 illustrates a monument workstation, in accordance with various embodiments;

FIG. 13 illustrates a monument workstation, in accordance with various embodiments;

FIG. 14 illustrates a monument workstation, in accordance with various embodiments;

FIG. 15 illustrates a monument workstation, in accordance with various embodiments; and

FIG. 16 illustrates a monument workstation, in accordance with various embodiments.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to “singular” includes plural embodiments, and any reference to “more than one” component or step may include a singular embodiment or step. Also, any reference to “attached,” “fixed,” “connected,” or the like may include permanent, removable, temporary, partial, full or any other possible attachment option. Additionally, any reference to “without contact” (or similar phrases) may also include reduced contact or minimal contact. It should also be understood that unless specifically stated otherwise, references to “a,” “an,” or “the” may include one or more than one and that reference to an item in the singular may also include the item in the plural. Further, all ranges may include upper and lower values and all ranges and ratio limits disclosed herein may be combined.

As used herein, “aft” refers to the direction associated with the tail (e.g., the back end) of an aircraft, or generally, to the direction of exhaust of the gas turbine. As used herein, “forward” refers to the direction associated with the nose (e.g., the front end) of an aircraft, or generally, to the direction of flight or motion. As used herein “rear” refers to the direction of the fuselage wall (e.g. away from an aisle). As used herein “front” refers to the direction facing the aircraft aisle (e.g. opposing the fuselage wall). As used herein “vertical” or “vertically” refers to the Z-direction. As used herein “lateral” or “laterally” refers to the Y-direction. As used herein “longitudinal” or “longitudinally” refers to the X-direction.

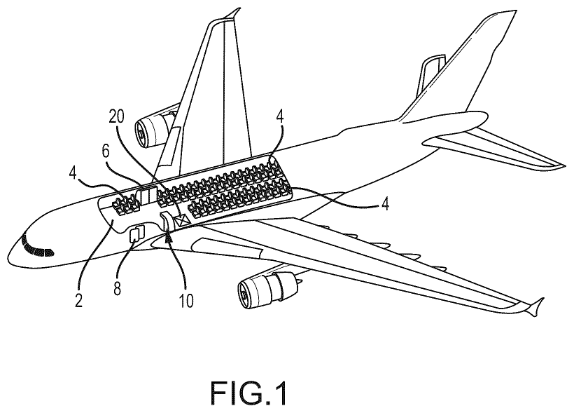

With initial reference to FIG. 1, an aircraft 1 is illustrated, in accordance with various embodiments. Aircraft 1 may comprise an aisle 2. Aircraft 1 may comprise a plurality of seats 4. Aircraft 1 may comprise one or more lavatories 6. Aircraft 1 may comprise a door 8. Aircraft 1 may comprise a monument system 10. Aircraft 1 may comprise a wheelchair plinth 20. Wheelchair plinth 20 may be disposed proximate door 8. Wheelchair plinth 20 may be disposed proximate monument system 10. Monument system 10 may be disposed proximate passenger seating disposed immediately aft of an open space. In the event that the wheelchair plinth 20 is unoccupied, the monument system 10 may be expanded as described further herein to provide an alternate workstation in the aircraft 1.

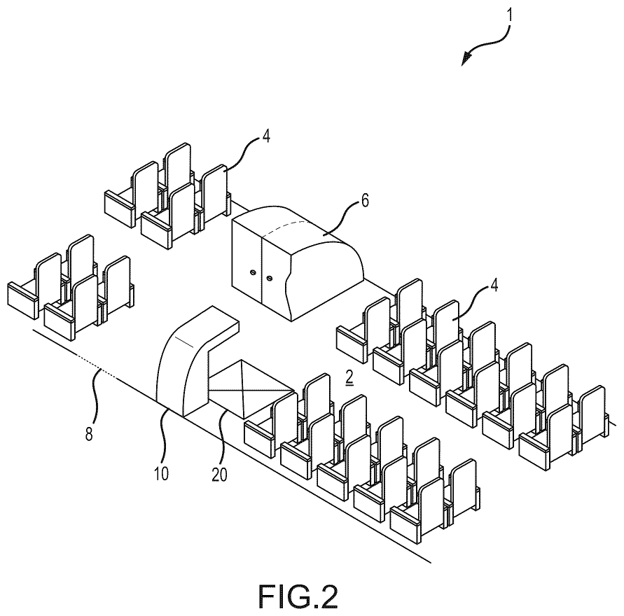

With initial reference to FIG. 2, a floor plan of aircraft 1 is illustrated, in accordance with various embodiments. As illustrated, wheelchair plinth 20 and monument system 10 are disposed aft of door 8. However, it should be understood that wheelchair plinth and/or monument system 10 may be disposed at any location within aircraft 1. As illustrated, monument system 10 is disposed outboard of wheelchair plinth 20 and face inboard toward aisle 2. However, it should be understood that monument system 10 may be disposed inboard of wheelchair plinth 20 and face outboard toward wheelchair plinth 20. While described as proximate a wheelchair plinth 20, it should be understood that monument may instead be disposed proximate an open space in the aircraft 1 or proximate passenger seating disposed immediately aft of an open space.

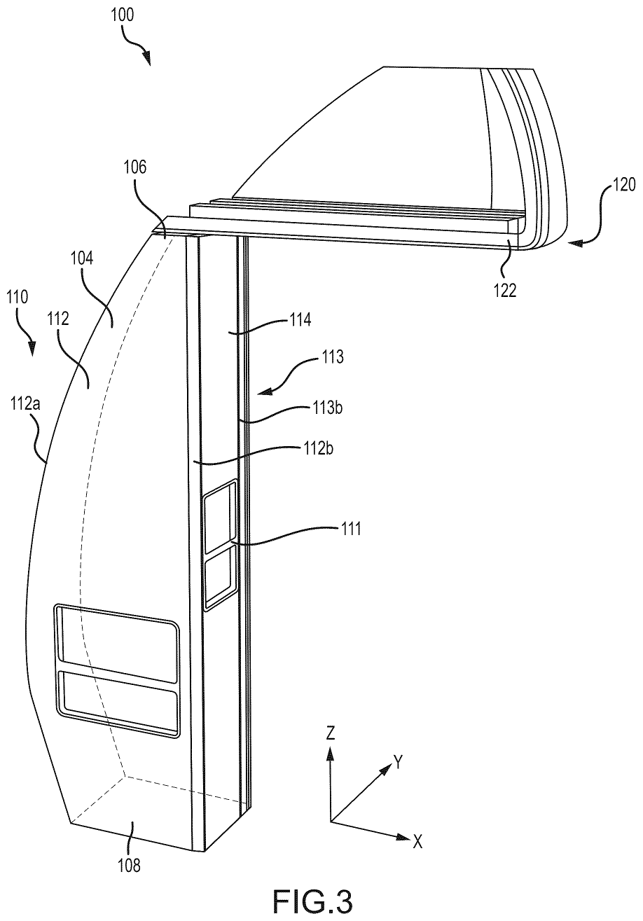

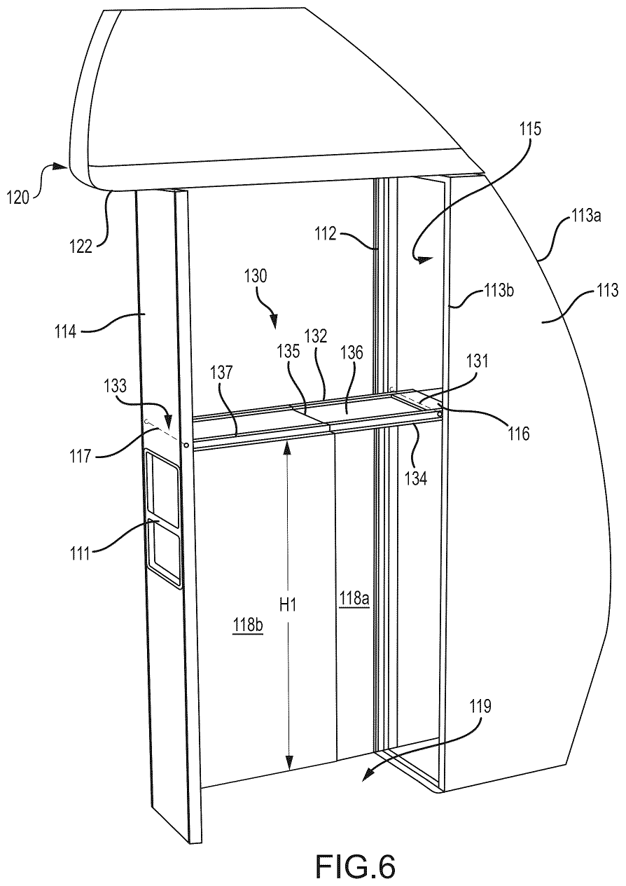

With reference to FIGS. 3-7, a monument system 100 is illustrated, in accordance with various embodiments. The monument system 100 may be similar to the monument system 10. The monument system 100 may comprise a monument 110. In various embodiments, the monument 110 comprises a ceiling 106 and a floor 108. In various embodiments, the monument 110 comprises a first sidewall 112 and a second sidewall 113. The monument 110 may comprise a front wall 114. The front wall 114 may be a translating wall. The monument 110 may comprise a rear wal1 104 opposing the front wall 114. The rear wall 104 may be dimensioned to fit against an outboard wall of the aircraft 1. The front wall 114 may be translatable with respect to the first sidewall 112 and the second sidewall 113. In various embodiments, the first sidewall 112 extends between a rear edge 112a and a front edge 112b. In various embodiments, the second sidewall 113 extends between a rear edge 113a and a front edge 113b. In various embodiments, the front wall 114 comprises a handle 111 for translating the front wall 114 with respect to the first sidewall 112 and the second sidewall 113.

The monument system 100 may comprise a rail system 120 for controlling the translation of the front wall 114. The rail system 120 provides guided, linear movement of the front wall 114 between the stowed position and the deployed position, ensuring consistent and repeatable deployment of the workstation 130. However, it should be understood that the application is not limited in this regard. In various embodiments, the monument system 100 does not comprise a rail system 120. The monument system 100 may comprise a workstation 130. The workstation 130 may be deployable from the monument 110. When the monument 110 is in the stowed position, the workstation 130 is stored within the monument 110, thereby conserving floor space and maintaining an unobstructed galley environment. The workstation 130 may comprise high-strength, lightweight materials such as aluminum, aluminum alloys, polyvinyl chloride (PVC) or other plastics, carbon-fiber reinforced plastic, aluminum skins disposed over PVC or honeycomb cores, or any other suitable material configured to withstand repeated deployment cycles and operational loads.

With reference to FIG. 3, the monument 110 is illustrated in a stowed position in which the front wall 114 is disposed against the front edge 112b of the first sidewall 112 and the front edge 113b of the second sidewall 113. In the stowed position, the front wall 114 is coupled to the first sidewall 112 and the second sidewall 113. In the stowed position, the front wall 114 is at a first longitudinal position. The first longitudinal position may be proximate the front edge 112b of the first sidewall 112 and the front edge 113b of the second sidewall 113.

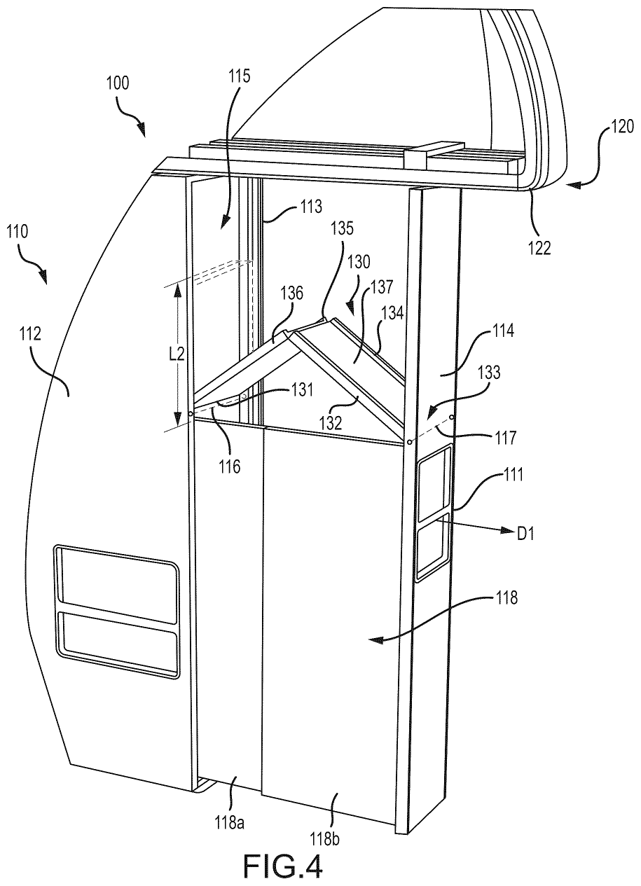

With reference to FIG. 4, the monument 110 is illustrated as translating from the stowed position to a deployed position. In operation, in response to a pulling force being applied to handle 111 in a first direction D1, the front wall 114 may be translated away from the first sidewall 112 and the second sidewall 113. This translation of the front wall 114 mechanically initiates deployment of the workstation 130 from the storage space 115. Conversely, applying a pushing force to handle 111 in a direction opposite of the first direction D1 causes the front wall 114 to translate toward the first sidewall 112 and the second sidewall 113, thereby returning the monument 110 from the deployed position to the stowed position. The mechanical linkage between the front wall 114 and the workstation 130 ensures that pulling or pushing the handle 111 simultaneously translates the front wall 114 and deploys or stows the workstation 130. In response to the monument 110 translating from the stowed position to the deployed position, the workstation 130 may be deployed from the storage space 115 disposed between the first sidewall 112 and the second sidewall 113.

In various embodiments, the workstation 130 extends from a rear edge 131 to a front edge 133 in a longitudinal direction, and from a first edge 132 to a second edge 134 in a lateral direction. The workstation 130 is coupled to the monument 110 via a first hinge 116 and a second hinge 117. Specifically, the first hinge 116 couples the rear edge 131 of the workstation 130 to at least one of the first sidewall 112 or the second sidewall 113. In various embodiments, the first hinge 116 couples the workstation 130 to both of the first sidewall 112 and the second sidewall 113, providing a stable rotational axis for the workstation 130. The second hinge 117 couples the front edge 133 of the workstation 130 to the front wall 114. The first hinge 116 defines a fixed pivot point about which the rear edge 131 of the workstation 130 rotates, while the second hinge 117 transmits the translational motion of the front wall 114 to the front edge 133 of the workstation 130, thereby converting the linear translation of the front wall 114 into rotational deployment of the workstation 130.

In various embodiments, the workstation 130 comprises a first panel 136 and a second panel 137 that are foldably coupled to each other at a center hinge 135. The first panel 136 and the second panel 137 fold with respect to each other at the center hinge 135 in response to translation of the front wall 114. During deployment, as the front wall 114 translates away from the first sidewall 112 and the second sidewall 113, the first panel 136 of the workstation 130 rotates about the first hinge 116 from a vertical position toward an extended position. Simultaneously, the second panel 137 of the workstation 130 rotates about the second hinge 117 from the vertical position toward the extended position. As the first panel 136 and the second panel 137 rotate, each unfolds with respect to each other at the center hinge 135, progressively flattening from a folded configuration to a planar configuration. In other words, as the monument 110 is converted from the stowed position to the deployed position, the workstation 130 unfolds in a longitudinal direction from the vertical position to the extended position through the coordinated rotation of the first panel 136, the second panel 137, and the unfolding action at the center hinge 135. During stowage, as the front wall 114 translates toward the stowed position, the first panel 136 rotates about the first hinge 116 from the extended position toward the vertical position, and the second panel 137 rotates about the second hinge 117 from the extended position toward the vertical position. Simultaneously, the first panel 136 and the second panel 137 fold toward each other at the center hinge 135, returning the workstation 130 to the folded, vertical configuration within the storage space 115.

In various embodiments, the total length L1 of the workstation 130, measured in the longitudinal direction when in the extended position, is greater than a folded length L2 of the workstation 130, measured in the longitudinal direction when in the vertical position. In various embodiments, the total length L1 of the workstation 130 may be twice the folded length L2 of the workstation 130. This configuration advantageously permits the workstation 130 to provide a work surface area substantially larger than the storage footprint used when the workstation 130 is in the stowed position, thereby tending to maximize the usable work surface while tending to minimize the storage space consumed within the monument 110.

In various embodiments, a panel wall 118 comprising a plurality of panel sections (for example, panel sections 118a, 118b) may be deployed from the monument 110 as the front wall 114 is pulled to the deployed position. The panel sections 118a, 118b may be overlapping in the stowed position and translated with respect to each other to reach the deployed position. In various embodiments, the panel wall 118 provides a privacy barrier. In various embodiments, the panel wall 118 provides structural support to the workstation 130 when in the deployed position. In various embodiments, the panel wall 118 is disposed proximate one of the first edge 132 or the second edge 134 of the workstation 130. As illustrated, the panel wall 118 is disposed proximate the first edge 132 of the workstation 130. However, it should be understood that in various embodiments, the panel wall 118 may be disposed proximate the second edge 134 of the workstation 130.

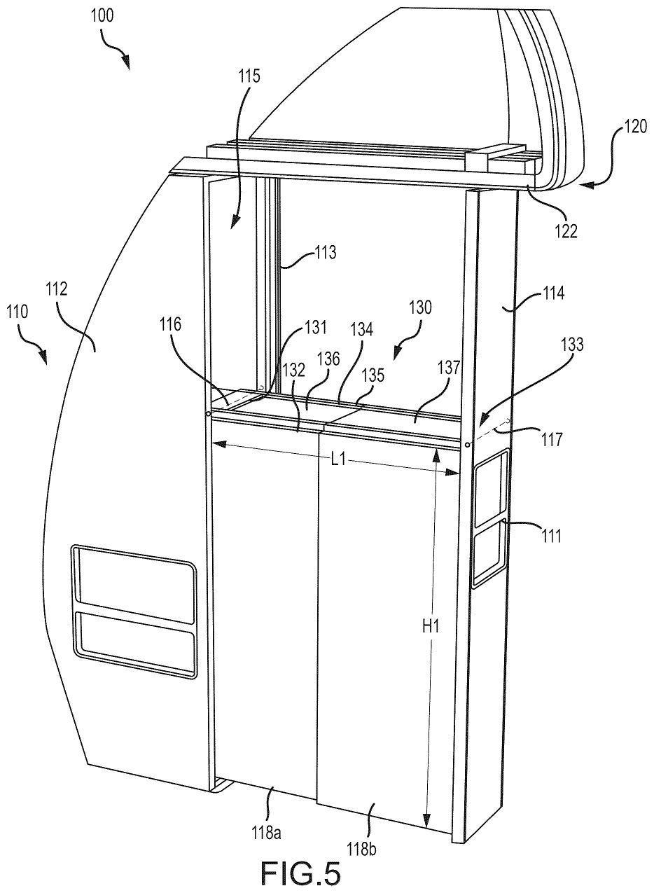

With respect to FIG. 5, the monument 110 is illustrated in a deployed position in which the front wall 114 is spaced apart from the first sidewall 112 and the second sidewall 113. In the deployed position, the front wall 114 is at a second longitudinal position. The second longitudinal position is spaced from the front edge 112b of the first sidewall 112 and the front edge 113b of the second sidewall 113. The second longitudinal position may be proximate a front end 122 of the rail system 120. In the deployed position, the workstation 130 is fully extended such that the first panel 136 and the second panel 137 are each in the extended position. In the extended position, the first panel 136 and the second panel 137 are substantially coplanar and together form a continuous, planar work surface extending in the longitudinal direction. In various embodiments, in response to the workstation 130 being fully extended, the front wall 114 may be locked into the deployed position by a locking mechanism, thereby securing the workstation 130 in the extended position during use. In response to initiating a fold of the workstation 130 at the center hinge 135, the locking mechanism may release the front wall 114, permitting the front wall 114 to translate toward the stowed position.

In various embodiments, when the monument 110 is in the deployed position, the workstation 130 forms a continuous worksurface at a first height H1. The first height H1 may be between 32 inches and 60 inches. The first height H1 may be between 38 inches and 52 inches. The first height H1 may be between 40 inches and 48 inches.

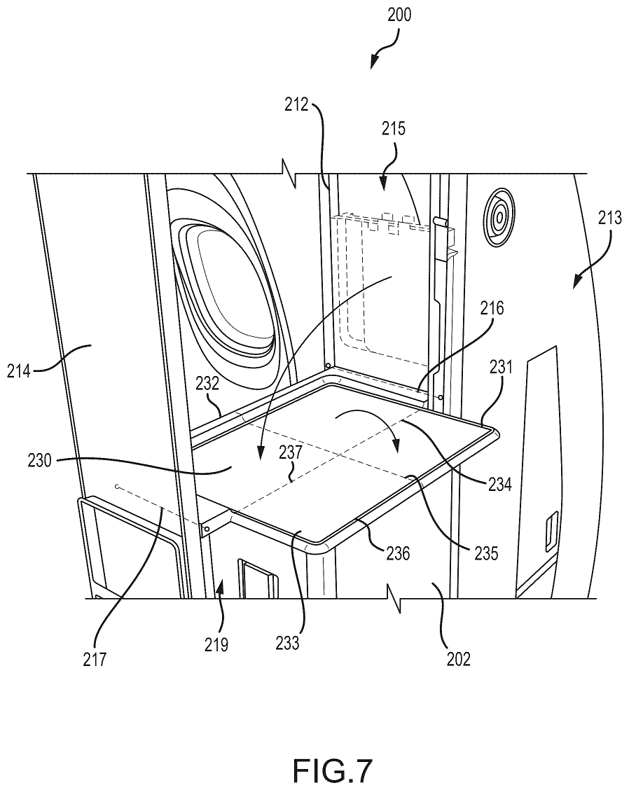

In various embodiments, the monument 110 may comprise a storage pocket 119 when the monument 110 is in the deployed position. The storage pocket 119 may be disposed between the front wall 114 and the threshold between the first sidewall 112 and the second sidewall 113. The storage pocket 119 may be dispose beneath the workstation 130. In various embodiments, the storage pocket 119 may be bounded by the panel wall 118. In various embodiments, the storage pocket 119 may be configured to receive a galley cart, such as galley cart 202 illustrated in FIG. 7.

With respect to FIG. 7, a monument system 200 is illustrated. The monument system 200 may be similar to the monument system 100 such that like numbering represents like elements. The monument system 200 may comprise a monument 210 having a front wall 214 translatable from a first sidewall 212 and a second sidewall 213 to deploy a workstation 230 from a storage space 215 of the monument 210. In various embodiments, the workstation 230 may be disposed in a vertical position within the storage space 215 when the monument 210 is in the stowed position. In various embodiments, the workstation 230 comprises collapsible quadrants formed by a plurality of panels foldable in both longitudinal and lateral directions. During deployment, as the monument 210 is converted to the deployed position, the workstation 230 unfolds in a first stage longitudinally from the vertical position to a first extended position. Once in the first extended position, the workstation 230 unfolds in a second stage laterally from the first extended position to a second extended position, thereby providing an extended worksurface above a storage pocket 219. This two-stage unfolding sequence advantageously provides an extended work surface area that is substantially larger than the footprint of the workstation 230 when in the vertical, stowed position. In various embodiments, a galley cart 202 may fit within the storage pocket 219, permitting simultaneous workstation deployment and cart storage. The monument system 200 may comprise a rail system 220 for controlling the translation of the front wall 214.

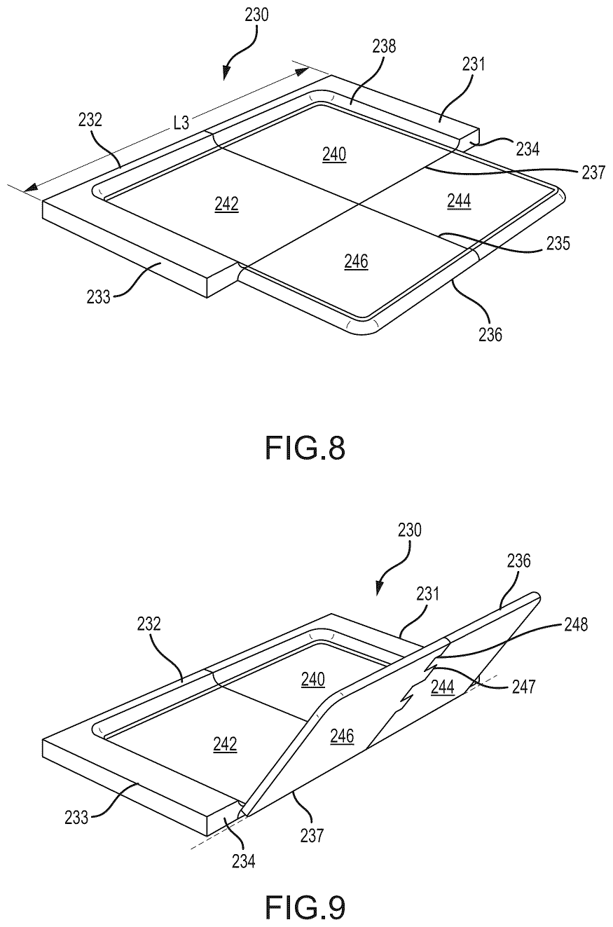

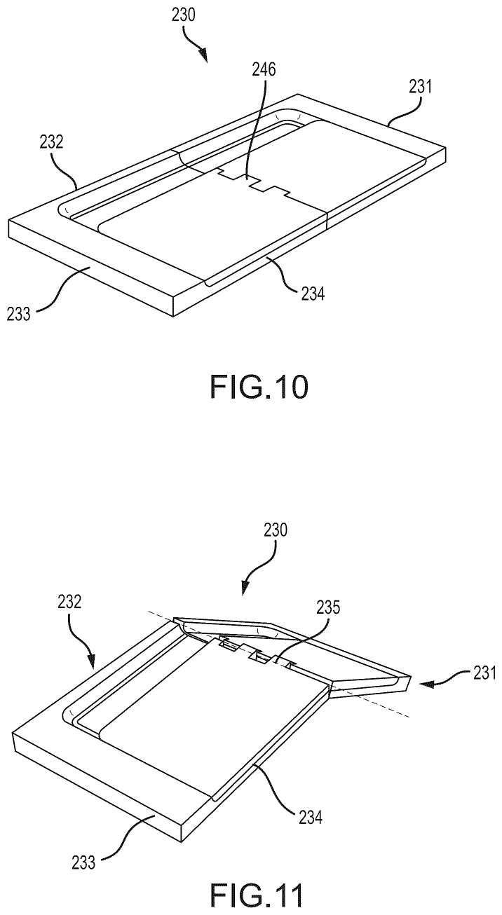

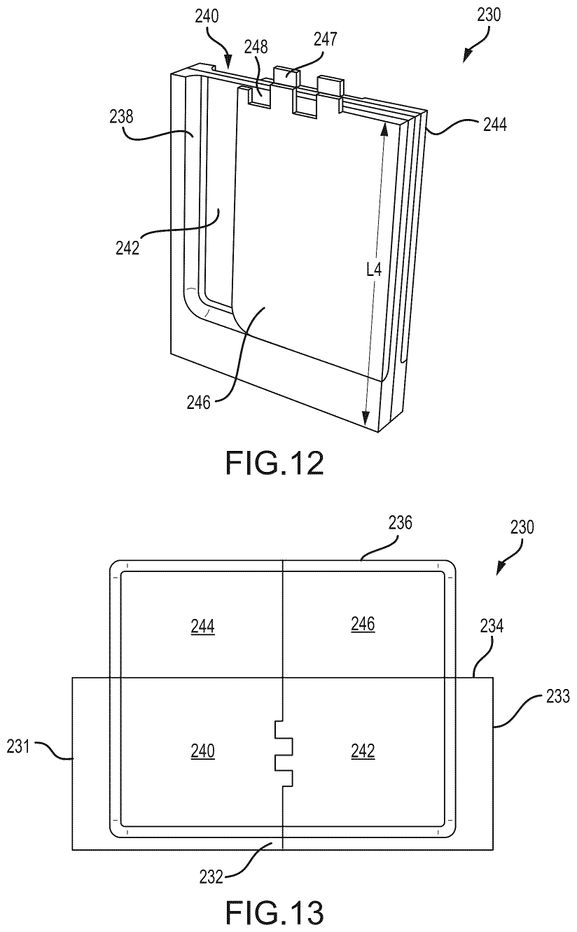

In various embodiments and with additional reference to FIGS. 8-13, the workstation 230 comprises a first panel 240, a second panel 242, a third panel 244, and a fourth panel 246 arranged in a quadrant configuration. In various embodiments, the first panel 240 and the second panel 242 of the workstation 230 together extend from a rear edge 231 to a front edge 233 of the workstation 230 in the longitudinal direction. The first panel 240 and the second panel 242 each extend from a first edge 232 to a second edge 234 of the workstation 230 in the lateral direction. The first panel 240 is coupled to at least one of (or both of) the first sidewall 212 and the second sidewall 213 via a first hinge 216. The first hinge 216 provides a fixed rotational axis about which the workstation 230 pivots during deployment. The second panel 242 may be coupled to the front wall 214 via a second hinge 217. The second hinge 217 transmits the translational motion of the front wall 214 to the workstation 230. The first panel 240 and the second panel 242 are coupled to each other at a center longitudinal hinge 235, and are foldable with respect to each other about the center longitudinal hinge 235. The third panel 244 and the fourth panel 246 are also coupled to each other at the center longitudinal hinge 235, and are foldable with respect to each other about the center longitudinal hinge 235. When the front wall 214 translates, the first panel 240 and the second panel 242 fold or unfold about the center longitudinal hinge 235 in the longitudinal direction, and the third panel 244 and the fourth panel 246 fold or unfold about the center longitudinal hinge 235 in the longitudinal direction.

In various embodiments, the center longitudinal hinge 235 may be formed by a plurality of interlocking teeth 247 extending from the first panel 240, the second panel 242, the third panel 244, and/or the fourth panel 246 along the center longitudinal hinge 235. Each interlocking tooth in the plurality of interlocking teeth 247 may be dimensioned to fit within a corresponding pocket 248 disposed on an opposing panel of the first panel 240, the second panel 242, the third panel 244, and/or the fourth panel 246. For example, an interlocking tooth in the plurality of interlocking teeth 247 extending from the first panel 240 may be dimensioned to fit within a pocket 248 of the second panel 242. An interlocking tooth 247 in the plurality of interlocking teeth extending from the second panel 242 may be dimensioned to fit within a pocket 248 of the first panel 240. For example, an interlocking tooth in the plurality of interlocking teeth 247 extending from the third panel 244 may be dimensioned to fit within a pocket 248 of the fourth panel 246. An interlocking tooth in the plurality of interlocking teeth 247 extending from the fourth panel 246 may be dimensioned to fit within a pocket 248 of the third panel 244.

In various embodiments, each of the third panel 244 and the fourth panel 246 extends between the second edge 234 and a third edge 236 in the lateral direction. The first panel 240 is coupled to and foldable with respect to the third panel 244 at a center lateral hinge 237. The second panel 242 is coupled to and foldable with respect to the fourth panel 246 at the center lateral hinge 237. The third panel 244 and the fourth panel 246 may be coupled to and foldable with respect to each other at the center lateral hinge 237. Accordingly, the center lateral hinge 237 enables the third panel 244 and the fourth panel 246 to fold laterally toward the first panel 240 and the second panel 242, respectively, during stowage, and to unfold laterally away from the first panel 240 and the second panel 242, respectively, during deployment. In various embodiments, the center lateral hinge 237 may be defined by interlocking teeth 247 and corresponding pockets 248 similar to the center longitudinal hinge 235, providing a robust, low-profile hinge connection that permits folding while maintaining structural integrity in the extended position.

In various embodiments, each of the first panel 240 and the second panel 242 is wider in the longitudinal direction than each of the third panel 244 and the fourth panel 246. In various embodiments, each of the first panel 240 and the second panel 242 is wider in the lateral direction than each of the third panel 244 and the fourth panel 246. Accordingly, the third panel 244 and the fourth panel 246 are dimensioned to nest within the first panel 240 and the second panel 242 when the workstation 230 is in the stowed position. The first panel 240 and the second panel 242 may each define a depression 238 dimensioned to receive the third panel 244 and the fourth panel 246, respectively, when the third panel 244 and the fourth panel 246 are folded toward the first panel 240 and the second panel 242. As such, when the workstation 230 is in the first extended position (i.e., after longitudinal unfolding but before lateral unfolding), bottom surfaces of the third panel 244 and the fourth panel 246 are disposed within the depressions 238 and may be flush with top surfaces of the first panel 240 and the second panel 242. However, the disclosure is not limited in this regard. For example, the first panel 240 and the second panel 242 may be without the depression 238 such that the top surfaces of the first panel 240 and the second panel 242 continuously abut the top surfaces of the third panel 244 and the fourth panel 246 when in the second extended position.

As described herein, the workstation 230 is coupled to the monument 210 via the first hinge 216 and the second hinge 217. However, the workstation 230 may be removable from the monument 210 by decoupling the workstation 230 from the first hinge 216 and/or the second hinge 217. In various embodiments, the workstation 230 is compatible with the monument 110 and may be installed thereon. In various embodiments, the workstation 230 may be disposed on top of the workstation 130 when workstation 130 is in the extended position in order to add the extended worksurface provided by the third panel 244 and the fourth panel 246 to the workstation 130. This modularity permits configuration of the monument with different workstation configurations based on operational requirements.

In various embodiments, the total length L3 of the workstation 230 may be greater than a folded length L4 of the workstation 230. In various embodiments, the total length L3 of the workstation 230 may be twice the folded length L4 of the workstation 230.

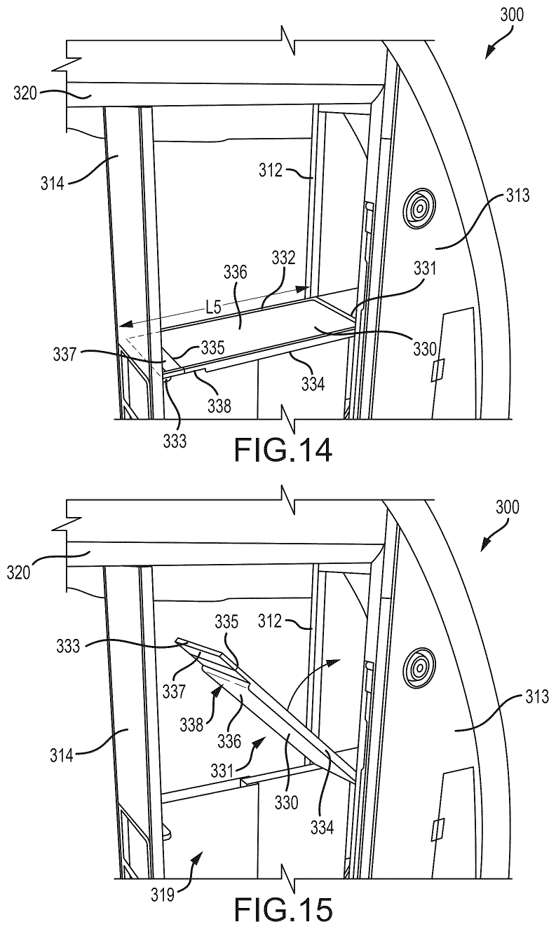

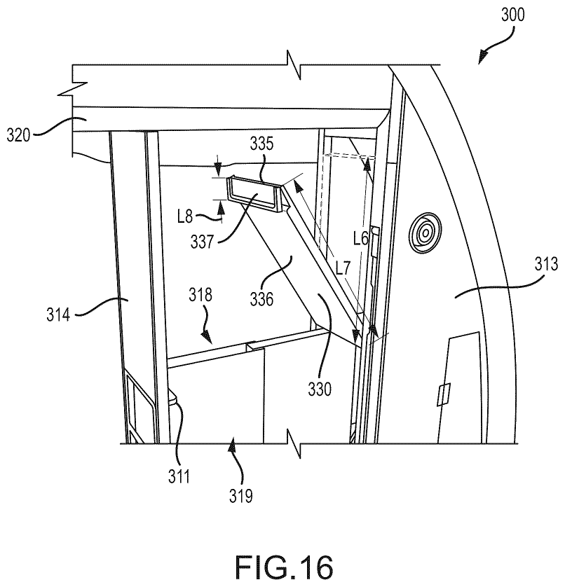

With respect to FIGS. 14-16, a monument system 300 is illustrated. The monument system 300 may be similar to the monument systems 100, 200 such that like numbering represents like elements. The monument system 300 may comprise a monument 310 having a front wall 314 translatable from a first sidewall 312 and a second sidewall 313 to deploy a workstation 330 from a storage space 315 of the monument 310. In various embodiments, the workstation 330 may be in a vertical position within the storage space 315 when the monument 310 is in the stowed position. In various embodiments, as the monument 310 is converted to the deployed position, the workstation 330 may unfold longitudinally from the vertical position to a first extended position. In various embodiments, a galley cart 302 may fit within the storage pocket 319. In various embodiments, the monument system 300 comprises a rail system 320 for controlling the translation of the front wall 314.

In various embodiments, the workstation 330 is a drawbridge-style workstation configured for single-hinge deployment. The workstation 330 extends from a rear edge 331 to a front edge 333 in the longitudinal direction, and from a first edge 332 to a second edge 334 in the lateral direction. The workstation 330 comprises a slab panel 336 extending from the rear edge 331 to a center hinge 335 of the workstation 330. The slab panel 336 is pivotably coupled to an approach panel 337 at the center hinge 335. The approach panel 337 may extend from the center hinge 335 to the front edge 333. In various embodiments, the slab panel 336 has a depression 338 formed in a bottom side of the slab panel 336. The depression 338 is dimensioned to receive the approach panel 337 when the approach panel 337 is folded toward the slab panel 336, thereby permitting the workstation 330 to assume a compact, folded configuration for stowage.

In various embodiments, the workstation 330 is coupled to the first sidewall 312 and the second sidewall 313 by a first hinge 316. The first hinge 316 provides a fixed pivot axis about which the workstation 330 rotates between the vertical position and the extended position. When the monument 310 is in the stowed position, the workstation 330 is received into the storage space 315 by rotating the workstation 330 about the first hinge 316 to the vertical position. When the workstation 330 is in the vertical position, the approach panel 337 is rotated about center hinge 335 such that the approach panel 337 is disposed within the depression 338 of the slab panel 336, thereby reducing the overall thickness of the workstation 330 in the folded configuration. When the workstation 330 is rotated about the first hinge 316 from the vertical position to the extended position during deployment, the approach panel 337 is rotated about center hinge 335 such that the approach panel 337 and the slab panel 336 together form a continuous, substantially planar workstation surface. This drawbridge-style deployment sequence permits a single rotational action to deploy the workstation 330 while providing a work surface length greater than the folded storage height.

In various embodiments, the total length L5 of the workstation 330, measured in the longitudinal direction when in the extended position, is greater than a folded length L6 of the workstation 330, measured in the vertical direction when in the stowed position. In various embodiments, the total length L5 of the workstation 330 is less than twice the folded length L6 of the workstation 330 because the approach panel 337 nests within the depression 338 of the slab panel 336 rather than folding adjacent to the slab panel 336. In various embodiments, a slab length L7 of the slab panel 336 is greater than an approach length L8 of the approach panel 337, permitting the approach panel 337 to be fully received within the depression 338.

In various embodiments, the front wall 314 may comprise a ledge 311 for receiving the front edge 333 of the approach panel 337. The approach panel 337 may be supported by the ledge 311.

Finally, it should be noted that while this disclosure is directed primarily to a workstation deployed from an aircraft monument, the concepts described herein may be applied to workstations deployed from alternative structures and in alternative environments. For example, workstations 130, 230, 330 may be configured to extend from an alternative structure such as a galley, seating, bulkheads, storage compartments, or similar aircraft fixtures. It is also contemplated that various combinations of panels and hinges, including but not limited to the specific configurations described herein, may be employed to construct a workstation deployable from a monument. The disclosed panel and hinge arrangements may be adapted to accommodate different spatial constraints, work surface size requirements, and deployment mechanisms while providing the advantages of space-efficient storage, single-action deployment, and unobstructed galley operations described herein.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” or “at least one of A, B, and C” is used in the specification or claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching may be used throughout the figures to denote different parts but not necessarily to denote the same or different materials.

Systems, methods, and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, it should be understood that any of the above-described concepts can be used alone or in combination with any or all of the other above-described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed is:

1. A monument, comprising:
a first sidewall extending between a ceiling and a floor;
a second sidewall extending between the ceiling and the floor;
a storage space disposed between the first sidewall and the second sidewall;
a front wall translatable from the first sidewall and the second sidewall; and
a workstation deployable from the storage space.

2. The monument of claim 1, wherein in response to the front wall being translated in a first direction, the workstation is free to deploy from a vertical position within the storage space to an extended position perpendicular to the front wall.

3. The monument of claim 2, wherein the workstation is rotatably coupled to the first sidewall and the second sidewall at a rear edge of the workstation via a first hinge.

4. The monument of claim 3, wherein the workstation is rotatably coupled to the front wall at a front edge of the workstation via a second hinge.

5. The monument of claim 4, wherein translation of the front wall in the first direction causes the workstation to deploy from the vertical position to the extended position.

6. The monument of claim 2, wherein the workstation comprises a first panel and a second panel coupled at a center hinge, wherein the workstation has a total length in the extended position and a folded length in the vertical position, and wherein the total length is greater than the folded length.

7. The monument of claim 6, wherein the workstation further comprises a third panel and a fourth panel coupled to the first panel and the second panel at a center lateral hinge.

8. The monument of claim 6, further comprising a ledge disposed on the front wall, wherein the first panel is a slab panel, the second panel is an approach panel configured to be supported by the ledge when in the extended position.

9. The monument of claim 1, further comprising a panel wall configured to extend from the storage space to form a privacy barrier.

10. The monument of claim 1, further comprising a handle disposed on the front wall for controlling a position of the front wall.

11. A monument, comprising:
a storage space disposed between a first sidewall and a second sidewall; and
a workstation deployable from the storage space to an extended position.

12. The monument of claim 11, wherein the workstation comprises:
a first panel coupled to the first sidewall and the second sidewall, and
a second panel rotatably coupled to the first panel.

13. The monument of claim 12, wherein the second panel is configured to unfold longitudinally from the first panel to form a continuous worksurface.

14. The monument of claim 13, wherein the workstation further comprises a third panel and a fourth panel, wherein the third panel is configured to unfold laterally from the first panel and the fourth panel is configured to unfold laterally from the second panel to form an extended worksurface.

15. A monument system, comprising:
a monument having a first sidewall, a second sidewall, a front wall configured to be disposed between the first sidewall and the second sidewall in a first longitudinal position and translatable from the first sidewall and the second sidewall to a second longitudinal position, and a storage space formed between the first sidewall and the second sidewall; and
a workstation configured to stow within the storage space in a vertical position and configured to deploy to an extended position in response to the front wall being translated to the second longitudinal position.

16. The monument system of claim 15, wherein the front wall comprises a ledge for receiving the workstation.

17. The monument system of claim 15, wherein the workstation is disposed at a height of between 32 inches and 60 inches when in the extended position.

18. The monument system of claim 15, wherein the workstation is coupled to the first sidewall and the second sidewall via a first hinge.

19. The monument system of claim 18, wherein the workstation is coupled to the front wall via a second hinge.

20. The monument system of claim 15, further comprising a rail system for controlling a position of the front wall.
